(19) United States
(12) Patent Application Publication
(10) Pub. No.: US 2024/0155447 A1
(43) Pub. Date: May 9, 2024

(54) OBTAINING TARGET CELL EPHEMERIS INFORMATION FOR HANDOVER CASES

(71) Applicant: NOKIA TECHNOLOGIES OY, Espoo (FI)

(72) Inventors: Jeroen WIGARD, Klarup (DK); Frank FREDERIKSEN, Klarup (DK)

(21) Appl. No.: 18/227,015

(22) Filed: Jul. 27, 2023

Related U.S. Application Data
(60) Provisional application No. 63/422,544, filed on Nov. 4, 2022.

(51) Int. Cl. H04W 36/00; H04W 36/36

(52) U.S. Cl. CPC H04W 36/00835; H04W 36/362; H04W 84/06

(57) ABSTRACT

Obtaining target cell ephemeris information for handover cases is provided. A method may be performed by a user equipment of acquiring, prior to initiating a handover, assistance information about each target neighboring cell in a list of candidate cells that is on the same satellite or a different satellite as a current cell to which the apparatus is currently connected. The handover may be performed from the current cell to one target neighboring cell from the generated list of candidate cells based on the assistance information.

### CROSS REFERENCE TO RELATED APPLICATION

This application claims the benefit of U.S. Provisional Application No. 63/422,544, filed Nov. 4, 2022. The entire content of the above-referenced application is hereby incorporated by reference.

### TECHNICAL FIELD

Some example embodiments may generally relate to mobile or wireless telecommunication systems, such as Long Term Evolution (LTE) or fifth generation (5G) new radio (NR) access technology, or 5G beyond, or other communications systems. For example, certain example embodiments may relate to obtaining target cell ephemeris information for handover cases.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. Fifth generation (5G) wireless systems refer to the next generation (NG) of radio systems and network architecture. 5G network technology is mostly based on new radio (NR) technology, but the 5G (or NG) network can also build on E-UTRAN radio. It is estimated that NR may provide bitrates on the order of 10-20 Gbit/s or higher, and may support at least enhanced mobile broadband (eMBB) and ultra-reliable low-latency communication (URLLC) as well as massive machine-type communication (mMTC). NR is expected to deliver extreme broadband and ultra-robust, low-latency connectivity and massive networking to support the Internet of Things (IoT).

### SUMMARY

Various exemplary embodiments provide an apparatus including at least one processor, and at least one memory. The memory storing instructions that, when executed by the at least one processor, cause the apparatus at least to acquire, prior to initiating a handover, assistance information about each target neighboring cell in a list of candidate cells that is on the same satellite or a different satellite as a current cell to which the apparatus is currently connected. The apparatus is further caused to perform the handover from the current cell to one target neighboring cell from the generated list of candidate cells based on the assistance information.

Certain exemplary embodiments provide an apparatus including means for acquiring, prior to initiating a handover, assistance information about each target neighboring cell in a list of candidate cells that is on the same satellite or a different satellite as a current cell to which the apparatus is currently connected. The apparatus also includes means for performing the handover from the current cell to one target neighboring cell from the generated list of candidate cells based on the assistance information.

Some exemplary embodiments provide a method of acquiring, prior to initiating a handover, assistance information about each target neighboring cell in a list of candidate cells that is on the same satellite or a different satellite as a current cell to which the apparatus is currently connected. The method also includes performing the handover from the current cell to one target neighboring cell from the generated list of candidate cells based on the assistance information.

Various exemplary embodiments provide a non-transitory computer readable medium including program instructions. The program instructions, when executed by an apparatus, cause the apparatus at least to acquire, prior to initiating a handover, assistance information about each target neighboring cell in a list of candidate cells that is on the same satellite or a different satellite as a current cell to which the apparatus is currently connected. The apparatus is further caused to perform the handover from the current cell to one target neighboring cell from the generated list of candidate cells based on the assistance information.

Certain exemplary embodiments provide a computer program including instructions stored thereon for performing one or more methods described herein. Further, some exemplary embodiments provide an apparatus including one or more circuitry configured to perform one or more methods described herein.

### BRIEF DESCRIPTION OF THE DRAWINGS

For proper understanding of example embodiments, reference should be made to the accompanying drawings, as follows:

FIG. 1 illustrates an example of a timeline of procedures for a UE performing a handover;

FIG. 2 illustrates an example of a timeline of procedures for handling the handover for cells classified in a first classification according to various exemplary embodiments;

FIG. 3 illustrates an example of a timeline of procedures for handling the handover for cells classified in a third classification according to various exemplary embodiments;

FIG. 4 illustrates an example of a flowchart of certain procedures according to certain exemplary embodiments;

FIG. 5 illustrates an example of a flow diagram of a method according to some exemplary embodiments; and

FIG. 6 illustrates an apparatus according to various exemplary embodiments.

### DETAILED DESCRIPTION

It will be readily understood that the components of certain example embodiments, as generally described and illustrated in the figures herein, may be arranged and designed in a wide variety of different configurations. The following is a detailed description of some exemplary embodiments of systems, methods, apparatuses, and non-transitory computer program products for obtaining target cell ephemeris information for handover cases. Although the devices discussed below and shown in the figures refer to 5G or low Earth orbit (LEO) satellites, Next Generation NodeB (gNB) devices and user equipment (UE) devices, this disclosure is not limited to only LEO satellites, gNBs. and UEs.

5G wireless systems may provide the ability for a mobile device or object to determines its relative location. Global Navigation Satellite System (GNSS) positioning may use one or more satellite signals to measure and/or detect the distance and/or relative position of a device, apparatus, node, and the like. GNSS may encompass global, regional, and augmentation satellite systems. Each GNSS may be used individually or in combination with others GNSSs, such as other global navigation systems, regional navigation systems and/or augmentation systems.

GNSS may be implemented with an NR network to function with an NG radio access network (NG-RAN). The NG-RAN may assist the UE GNSS receiver to improve the performance in several respects. The network-assisted GNSSs may utilize communications between UE GNSS receivers and a GNSS reference receiver network.

Non-terrestrial networks (NTN) may be supported by the NR network and implemented into 5G wireless systems. For example, LEO satellites may transparently relay signals between a UE and a gNB on Earth, such that coverage & service can be provided to increase a communication distance for the UE, which is far away from any terrestrial base station. LEO satellites move in orbit relative to the Earth at a specified altitude. For example, LEO satellites may orbit at approximately 7.5 km/s relative to Earth and may be located at altitudes of approximately 600-1,500 kilometers (km).

3^{rd} Generation Partnership Project (3GPP) Release 17 (Rel-17) provided for an implementation of NTN in 5G in which of the UE may be primarily responsible for performing pre-compensation of uplink (UL) transmissions. The pre-compensation may be performed to preemptively compensate for propagation delay and/or Doppler shift observed by the UE due to, for example, a speed and/or altitude of the orbit of the LEO satellite. The UE may determine or otherwise know of its own location by, for example, using GNSS, and the UE may receive satellite position information including current and future positions in space of the LEO satellite. The satellite position information may also be known as ephemeris and may be provided to the UE by system information broadcast (SIB) messages from the LEO satellite. The SIB may also include information on how the timing between the gNB and the satellite varies over time, which may be referred to as a common timing advance (TA). The timing information may be included in an SIB referred to as SIB19, which may be transmitted regularly and frequently to facilitate proper operation of the system. The ephemeris and common TA may collectively form assistance information. 3GPP TS 38.331 may provide further information and context to the UE acquiring SIB19.

The assistance information may not remain valid forever, and thus may need to be updated, renewed, and/or determined again. In NR, assistance information may be associated with a validity time duration and an epoch time. The epoch time may be a time at which the UE may assume the assistance information is valid. The epoch time may be indicated in radio frame and slot using the NR over NTN internal description of time. Since the assistance information contains time varying parameters, such as the common TA descriptors and the satellite position, the UE may require a time at which the UE can assume this information to be applicable in order for the UE to establish the satellite's position in space at different times. The provisioning of the epoch time and validity time duration may enable the UE to determine at which time the assistance information may be considered valid and for how long. The UE starts the validity timer corresponding to the network-provided validity duration at the epoch time.

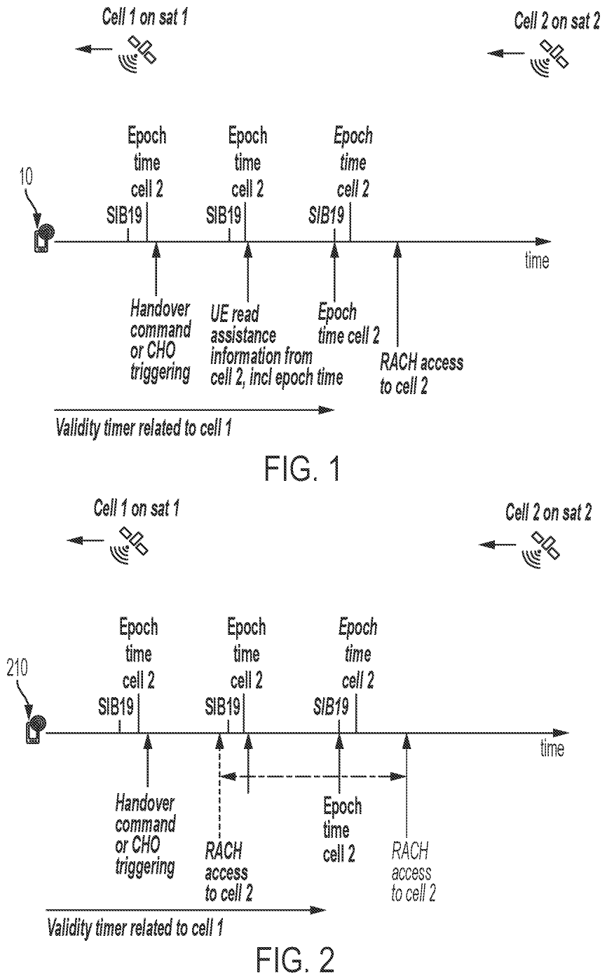

As the UE and/or the satellite change relative position, a handover procedure may be used to switch the UE from a current cell to another cell of the same satellite or a different satellite. As shown in the example of FIG. 1, a UE 10 may be connected to a network that is connected to one or more satellites, such as SAT #1 and SAT #2. The UE 10 may be provided with a command or may satisfy a trigger event to initiate a handover. FIG. 1 illustrates a timeline of events in the UE 10 performing the handover procedure from Cell 1 of SAT #1 to Cell 2 of SAT #2. The network may assign the UE a dedicated random access preamble for contention free access. The UE may read serving satellite ephemeris from a new satellite, which is located within SIB scheduling windows, that has periodicities from 80 ms to 5 seconds. To shorten the initial access delay, the cells may be configured with a physical random access channel (PRACH) configuration including such that a random access channel (RACH) occurs every 40 ms or less, which may be referred to as a RACH opportunity.

In particular, the UE may receive the trigger and the indication of which RACH opportunity and random access preamble to use for contention free access, which may occur before the epoch time of next SIB19 in the new target cell. However, the UE may not be able to perform the random access preamble transmission since the UE does not have a valid UL synchronization until a future SIB19. This may cause delay in the handover procedure. The UE may have to wait for another SIB scheduling window containing SIB19, which may not occur in the next upcoming SIB scheduling window. The UE may additionally have to delay/wait for the epoch time of the provided assistance information, which may not occur until the end of SIB scheduling window or a certain period of time thereafter, such as up to 10 seconds. After the epoch time, the UE may additionally have to delay/wait until the next upcoming RACH opportunity/occasion (RO) to be able to perform a valid random access preamble transmission. According to some exemplary embodiments, the dedicated preamble that the UE was originally assigned may have expired, which may cause the UE to use the contention based random access procedure. This may have longer access delay due to a risk of collisions on the RACH.

Various exemplary embodiments may advantageously address the above-described considerations by reducing the amount of delay/wait time during the handover procedure performed by the UE. The various exemplary embodiments may be able to reduce or eliminate interruption caused by delay during the handover.

According various exemplary embodiments, an apparatus, such as a UE, may be connected to or a part of a NR wireless network. The UE may be connected to a current cell of a satellite. The UE measures the neighbouring cell(s) by measuring the synchronization signal block (SSB) and a physical broadcast channel (PBCH) of the SSB, which may include a master information block (MIB). The UE may measure the neighbouring cell(s) continuously or approximately continuously, periodically, intermittently, at defined intervals, or at any other time as desired.

Based on the measurement of the neighbouring cell(s), the UE may determine a frequency offset based on the measurement(s). For example, the frequency offset may be determined to compensate for the Doppler effect of each target cell of the neighboring cell(s). The neighboring cell(s) that have been measured may be divided into multiple classifications/classes. According to some exemplary embodiments, the multiple classifications may be divided into 3 classifications, which are respectively based on whether the neighboring cell is the same cell as the current cell, a different cell than the current cell and moving away from the UE, or a different cell than the current cell and moving towards the UE.

A first classification may be for neighboring cells that are on a different satellite and moving away from the UE. The UE may detect that the neighboring cell is moving away from the UE based on a negative frequency offset (Doppler) relative to a carrier frequency.

A second classification may be for neighbouring cells that are on the same satellite as the current cell. The UE may determine to classify one or more neighboring cells in the second classification based on the frequency offset of a potential target cell, which may be due to the Doppler effect, being the same as the current cell.

A third classification may be for neighboring cells that are on a different satellite and moving towards the UE. The UE may detect that the neighboring cell is moving towards from the UE based on a positive frequency offset (Doppler) relative to the carrier frequency.

The UE generates a list of candidate cells that includes the neighboring cells in the classifications. The UE may generate and send a report to the network including a list of neighboring cells that satisfy handover triggers based on the measurements, which may be referred to as reported cells. The network may decide or determine which cell to perform the handover to and provides a handover command instructing the UE to switch to a determined cell. In some exemplary embodiments, the UE may additionally or alternatively be configured with a conditional handover to certain cells, which are referred to as cho_cells. For the conditional handover, the UE performs measurements of the neighbouring cell(s), evaluates the measurements, and selects a first cell that satisfies the conditions for access to the cell and/or for the handover, without requesting the cell or an indication of the cell from the network. The candidate handover cells may include the reported cells and the cho_cells.

The UE then filters or removes the cells with the negative frequency offset from the candidate handover cells list. For example, the UE filters all cells in the first classification. The filtered list of cells thus includes cells in the second classification and the third classification. The candidate handover cells list no longer includes cells that are already about to leave the coverage area of the UE.

FIG. 2 illustrates an example of a timeline of procedures for handling the handover for cells classified in the second classification. According to certain exemplary embodiments for a UE 210, for cells classified in the second classification, the UE 210 may not read new ephemeris information because the ephemeris information may be the same as the ephemeris information of the current cell. The UE 210 may adopt the ephemeris information of the current cell and continue operation on the new cell without the need to re-acquire SIB19 for new/target cell. Alternatively, the UE 210 may reset the validity timer at the epoch time of the new cell. This may eliminate a need for the UE 210 to wait for reading SIB19. As a further alternative, the UE 210 may first adopt the ephemeris information of the current cell, and once the validity timer expires the UE 210 may reset the validity timer.

FIG. 2 illustrates that the UE 210 may be connected to Cell 1 of SAT #1 with a validity timer activated. The UE 210 may receive a handover command or a conditional handover (CHO) trigger may be satisfied. The UE may receive RACH access to Cell 2 of SAT #1 during the pendency of the validity timer for Cell 1 of SAT #1. Cell 2 of SAT #1 may be classified into the second classification. The UE 210 may adopt the ephemeris information of the current cell and continue operation on the new cell without the need to re-acquire SIB19 for new/target cell. The UE 210 may be able to establish RACH access to Cell 2 without waiting until the next SIB19. In FIG. 2, the horizontal line extending between the two instances of “RACH access to cell 2” shows the potential time saved and delay avoided by this procedure according to various exemplary embodiments.

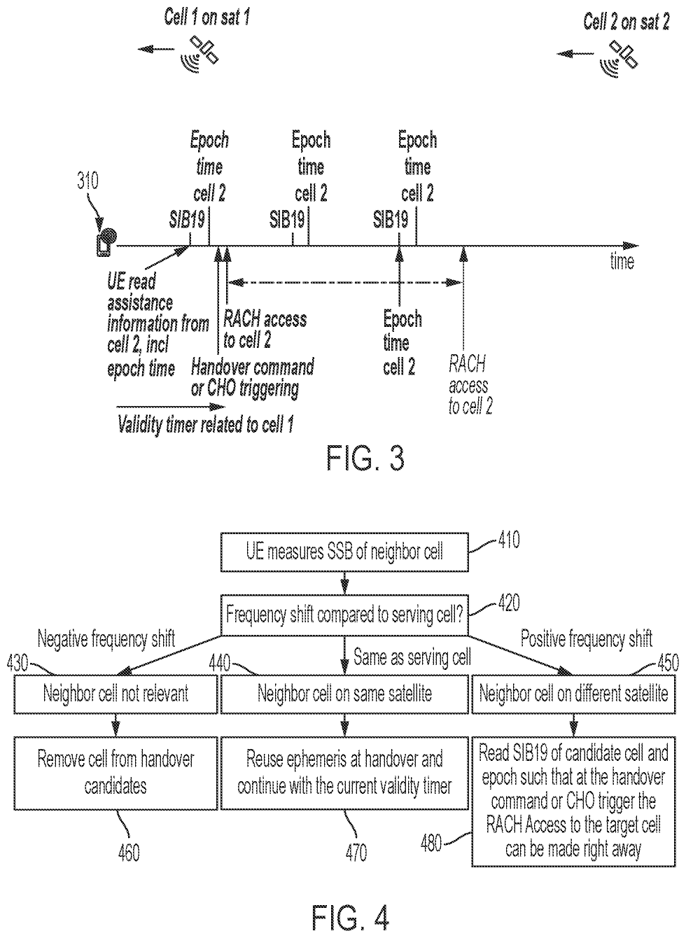

FIG. 3 illustrates an example of a timeline of procedures for handling the handover for cells classified in the third classification. According to certain exemplary embodiments for a UE 310, for cells classified in the third classification, the UE 310 may proactively read the SIB19 of the cells in the list of candidate cells for the third classification. The UE 310 may act proactively by reading the SIB19 before the handover trigger occurs or before the handover is initiated. The UE 310 may read the assistance information in the SIB 19, which includes the epoch time. For example, the UE 310 may read the assistance information for Cell 2 of SAT #2 to determine the epoch time. The UE 310 may then wait for a next RACH opportunity, and perform the handover to access Cell 2 of SAT #2 at the next RACH opportunity.

As shown in FIG. 3, the UE 310 may read the SIB19 prior to the handover command or CHO trigger. The UE 310 may then gain access to Cell 2 at the next RACH opportunity. In FIG. 3, the horizontal line extending between the two instances of “RACH access to cell 2” shows the potential time saved and delay avoided by this procedure according to various exemplary embodiments.

FIG. 4 illustrates a flowchart of certain procedures according to various exemplary embodiments. At 410, a UE performs measurements of one or more neighboring cells. The UE may measure various parameters of the one or more neighboring cells. For example, the UE may measure the SSB of the one or more neighboring cells. During the measurement of the one or more neighboring cells, the UE may observe the physical properties of the measured signal. At 420, the UE may observe the Doppler offset, which is the frequency offset or shift relative to the carrier frequency, from the measurements performed on the one or more neighboring cells. The UE may also determine and/or acquire the frequency offset or shift of the current cell of the UE. The UE may compare the frequency offset or shift of the current cell with the measured frequency offset or shift of the one or more neighboring cells.

At 430 through 450, the UE may classify the one or more neighboring cells into three classifications based on the comparison of the frequency offset or shift of the current cell with the measured frequency offset or shift of the one or more neighboring cells. At 430, the UE may classify neighboring cells into a first classification when the relative frequency offset or shift is negative. The UE may then designate or indicate that any neighboring cells classified in the first classification may be deemed to be not relevant to the handover procedure. At 440, the UE may classify neighboring cells into a second classification when the relative frequency offset or shift indicates that the respective neighboring cell has the same frequency offset or shift as the current cell. The UE may then designate or indicate that any neighboring cells classified in the second classification may be deemed to be on the same satellite for the handover procedure. At 450, the UE may classify neighboring cells into a third classification when the relative frequency offset or shift indicates that the respective neighboring cell has a positive frequency offset or shift relative to the current cell. The UE may then designate or indicate that any neighboring cells classified in the third classification may be deemed to be on a different satellite for the handover procedure.

At 460, for any neighboring cell that is classified in the first classification at 430, the UE removes the cell from a list of candidate cells as the cells have been deemed to be not relevant to the handover procedure.

At 470, for any neighboring cell that is classified in the second classification at 440, the UE may adopt the ephemeris information of the current cell and continue operation on the new cell without the need to re-acquire SIB19 for new/target cell. The neighboring cell(s) classified in the second classification may be included in the measurement report if the neighboring cell(s) also satisfy other conditions for allowing access to the neighboring cell(s) by the UE, such as reference signal received power (RSRP), reference signal received quality (RSRQ). The neighboring cell(s) of the second classification may be included in the list of candidate cells.

At 480, for any neighboring cell that is classified in the third classification at 450, the UE may proactively read the SIB19 of the respective neighboring cell before the handover command and/or the CHO handover trigger is satisfied. The UE may read the assistance information in the SIB 19, which includes the epoch time. The UE may then wait for a next RACH opportunity, and perform the handover at the next RACH opportunity. The neighboring cell(s) of the third classification may be included in the list of candidate cells.

The list of candidate cells may be included in the report to the network, which may also be referred to as the measurement report. Upon transmitting the measurement report to the network, the UE may determine if the measurement report includes candidate cells that belong to a different satellite than the current satellite based on the classifications.

When the measurement report contains candidate cells belonging to a different satellite in the list of candidate cells, the UE may preemptively start searching for system information, such as master information block (MIB), SIB1 for essential system information, and/or SIB19 for satellite ephemeris information of the candidate neighbor cell(s). The UE may use the system information to attempt to ensure that the UE has obtained valid ephemeris information in case of a handover trigger for either a CHO or HO command from the network. Upon receiving the CHO or HO command from the network, the UE performs the handover to one of the neighboring cells in the list of candidate neighbor cells. For example, the one cell of the neighboring cells in the list of candidate neighbor cells may be the first cell to satisfy conditions for the handover and/or the access to the cell by the UE.

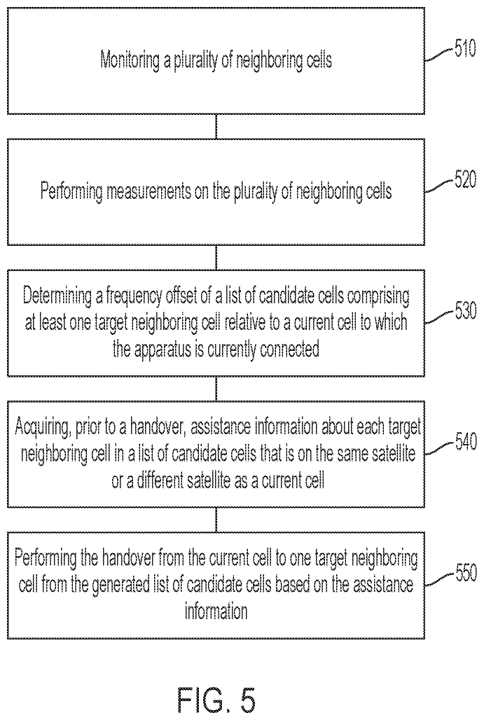

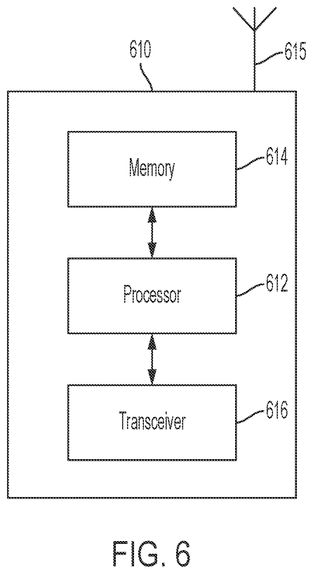

FIG. 5 illustrates an example flow diagram of a method, according to various exemplary embodiments. In an exemplary embodiment, the method of FIG. 5 may be performed by a network element, or a group of multiple network elements in a 3GPP system, such as LTE or 5G-NR. For instance, in an exemplary embodiment, the method of FIG. 5 may be performed by a UE similar to apparatus 610 illustrated in FIG. 6.

According to various exemplary embodiments, the method of FIG. 5 may include, at 510, monitoring a plurality of neighboring cells. At 520, the apparatus 610 may perform measurements on the plurality of neighboring cells. At 530, the apparatus 610 may determine a frequency offset of a list of candidate cells. The list may include at least one target neighboring cell relative to a current cell to which the apparatus is currently connected. Each frequency offset may be determined by comparing the respective measurement of each target neighboring cell relative to the current cell. Each frequency offset is determined based on measurements of a synchronization information block of the respective target neighboring cell.

At 540, the method may acquire, prior to initiating a handover, assistance information about each target neighboring cell in a list of candidate cells that is on the same satellite or a different satellite as a current cell to which the apparatus is currently connected. The assistance information is acquired about each target neighboring cell in the generated list of candidate cells that is determined to have a non-negative frequency offset. The non-negative frequency offset may be a positive value or a value indicating that the target neighboring cell of the same satellite as the current cell. At 550, the method may perform the handover from the current cell to one target neighboring cell from the generated list of candidate cells based on the assistance information. The handover is initiated by a handover command from a network entity or in response to satisfying a conditional handover trigger.

According to various exemplary embodiments, the assistance information may include an epoch time.

According to various exemplary embodiments, the apparatus 610 may classify each target neighboring cell in the list of candidate cells based on the determined frequency offset. Each target neighboring cell may be classified into one classification of a plurality of classifications. A first classification for one or more target neighboring cells may have a determined frequency offset that is negative. A second classification for one or more target neighboring cells may have a determined frequency offset that indicates that the target neighboring cells are on a same satellite as the current cell. A third classification for one or more target neighboring cells may have a determined frequency offset that is positive.

According to various exemplary embodiments, the apparatus 610 may filter the list of candidate cells by removing the one or more target neighboring cells classified as the first classification. The assistance information may be acquired for each target neighboring cell in the generated list of candidate cells that is in the second classification or the third classification.

For the one or more target neighboring cells that may be classified in the second classification, the apparatus 610 may be further caused at least to set ephemeris information in an assistance information of the one or more target neighboring cells to be equal to ephemeris information of the current cell. The apparatus 610 may also perform the handover continuing to use a validity timer of the current cell as a validity timer of the one or more target neighboring cells classified in the second classification.

For the one or more target neighboring cells that may be classified in the second classification, the apparatus 610 may be further caused at least to set ephemeris information in an assistance information of the one or more target neighboring cells to be equal to ephemeris information of the current cell. The handover may be performed by resetting a validity timer of the current cell as a validity timer of the one or more target neighboring cells classified in the second classification.

For the one or more target neighboring cells that may be classified in the third classification, the apparatus 610 may be further caused at least to read, prior to the handover, ephemeris information in the assistance information of the one or more target neighboring cells and an epoch time. The handover may be performed using the assistance information of the one or more target neighboring cells classified in the third classification.

According to certain exemplary embodiments, each frequency offset may be determined based on measurements of a synchronization information block of the respective target neighboring cell. The handover may be performed in response to a handover command from a network entity or in response to satisfying a conditional handover trigger.

According to some exemplary embodiments, the apparatus 610 may monitor a plurality of neighboring cells and may perform measurements on the plurality of neighboring cells. The frequency offset of the list of candidate cells may be determined based on the measurements performed on the plurality of neighboring cells.

According to some exemplary embodiments, the apparatus 610 may generate a report comprising the list of candidate cells, and transmit the report to a network entity. The apparatus 610 may further receive a handover command from the network indicating the one target neighboring cell from the generated list of candidate cells.

According to certain exemplary embodiments, the apparatus 610 may set ephemeris information in an assistance information of the one or more target neighboring cells to be equal to ephemeris information of the current cell. The apparatus 610 may also perform the handover by continuing to use a validity timer of the current cell as a validity timer of the one or more target neighboring cells that are on the same satellite as the current cell.

FIG. 6 illustrates apparatus 610 according to various exemplary embodiments. In the various exemplary embodiments, the apparatus 610 may be an element in a communications network or associated with such a network, such as a UE, RedCap UE, SL UE, mobile equipment (ME), mobile station, mobile device, stationary device, IoT device, or other device. UE 210 and UE 310 may be examples of apparatus 610 according to various exemplary embodiments as discussed above. It should be noted that one of ordinary skill in the art would understand that apparatus 610 may include components or features not shown in FIG. 6.

According to various exemplary embodiments, the apparatus 610 may include at least one processor, and at least one memory, as shown in FIG. 6. The memory may store instructions that, when executed by the processor, cause the apparatus 610 to acquire, prior to initiating a handover, assistance information about each target neighboring cell in a list of candidate cells that is on the same satellite or a different satellite as a current cell to which the apparatus is currently connected. The apparatus 610 may also be caused to perform the handover from the current cell to one target neighboring cell from the generated list of candidate cells based on the assistance information.

In some example embodiments, apparatus 610 may include one or more processors, one or more computer-readable storage medium (for example, memory, storage, or the like), one or more radio access components (for example, a modem, a transceiver, or the like), and/or a user interface. In some example embodiments, apparatus 610 may be configured to operate using one or more radio access technologies, such as GSM, LTE, LTE-A, NR, 5G, WLAN, WiFi, NB-IoT, Bluetooth, NFC, MulteFire, and/or any other radio access technologies.

As illustrated in the example of FIG. 6, apparatus 610 may include or be coupled to processor 612 for processing information and executing instructions or operations. Processor 612 may be any type of general or specific purpose processor. In fact, processor 612 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 612 for apparatus 610 is shown in FIG. 6, multiple processors may be utilized according to other example embodiments. For example, it should be understood that, in certain example embodiments, apparatus 610 may include two or more processors that may form a multiprocessor system (for example, in this case processor 612 may represent a multiprocessor) that may support multiprocessing. According to certain example embodiments, the multiprocessor system may be tightly coupled or loosely coupled to, for example, form a computer cluster).

Processor 612 may perform functions associated with the operation of apparatus 610 including, as some examples, precoding of antenna gain/phase parameters, encoding and decoding of individual bits forming a communication message, formatting of information, and overall control of the apparatus 610, including processes illustrated in FIGS. 2-5.

Apparatus 610 may further include or be coupled to memory 614 (internal or external), which may be coupled to processor 612, for storing information and instructions that may be executed by processor 612. Memory 614 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 614 can include any combination of random access memory (RAM), read only memory (ROM), static storage such as a magnetic or optical disk, hard disk drive (HDD), or any other type of non-transitory machine or computer readable media. The instructions stored in memory 614 may include program instructions or computer program code that, when executed by processor 612, enable the apparatus 610 to perform tasks as described herein.

In certain example embodiments, apparatus 610 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 612 and/or apparatus 610 to perform any of the methods illustrated in FIGS. 2-5.

In some exemplary embodiments, apparatus 610 may also include or be coupled to one or more antennas 615 for receiving a downlink signal and for transmitting via an uplink from apparatus 610. Apparatus 610 may further include a transceiver 616 configured to transmit and receive information. The transceiver 616 may also include a radio interface that may correspond to a plurality of radio access technologies including one or more of GSM, LTE, LTE-A, 5G, NR, WLAN, NB-IoT, Bluetooth, BT-LE, NFC, RFID, UWB, or the like. The radio interface may include other components, such as filters, converters (for example, digital-to-analog converters or the like), symbol demappers, signal shaping components, an Inverse Fast Fourier Transform (IFFT) module, or the like, to process symbols, such as OFDMA symbols, carried by a downlink or an uplink.

For instance, transceiver 616 may be respectively configured to modulate information on to a carrier waveform for transmission, and demodulate received information for further processing by other elements of apparatus 610. In other example embodiments, transceiver 616 may be capable of transmitting and receiving signals or data directly. Additionally or alternatively, in some example embodiments, apparatus 610 may include an input and/or output device (I/O device). In certain example embodiments, apparatus 610 may further include a user interface, such as a graphical user interface or touchscreen.

In certain example embodiments, memory 614 stores software modules that provide functionality when executed by processor 612. The modules may include, for example, an operating system that provides operating system functionality for apparatus 610. The memory 614 may also store one or more functional modules, such as an application or program, to provide additional functionality for apparatus 610. The components of apparatus 610 may be implemented in hardware, or as any suitable combination of hardware and software. According to certain example embodiments, apparatus 610 may optionally be configured to communicate with one or more satellites, such as GEO and/or LEO satellites, according to any radio access technology, such as NR.

According to certain example embodiments, processor 612 and memory 614 may be included in or may form a part of processing circuitry or control circuitry. In addition, in some example embodiments, transceiver 616 may be included in or may form a part of transceiving circuitry.

As used herein, the term “circuitry” may refer to hardware-only circuitry implementations (for example, analog and/or digital circuitry), combinations of hardware circuits and software, combinations of analog and/or digital hardware circuits with software/firmware, any portions of hardware processor(s) with software, including digital signal processors, that work together to cause an apparatus (for example, apparatus 610) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor or multiple processors, or portion of a hardware circuit or processor, and the accompanying software and/or firmware. The term circuitry may also cover, for example, a baseband integrated circuit in a server, cellular network node or device, or other computing or network device.

A computer program product may include one or more computer-executable components which, when the program is run, are configured to carry out some example embodiments. The one or more computer-executable components may be at least one software code or portions of it. Modifications and configurations required for implementing functionality of certain example embodiments may be performed as routine(s), which may be implemented as added or updated software routine(s). Software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (for example, apparatuses 610), for example through the use of an application specific integrated circuit (ASIC), a programmable gate array (PGA), a field programmable gate array (FPGA), or any other combination of hardware and software. In yet another example embodiment, the functionality may be implemented as a signal, a non-tangible means that can be carried by an electromagnetic signal downloaded from the Internet or other network.

According to certain example embodiments, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily refer to the same group of embodiments, and the described features, structures, or characteristics may be combined in any suitable manner in one or more example embodiments. Further, the terms “cell”, “node”, “gNB”, or other similar language throughout this specification may be used interchangeably.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

One having ordinary skill in the art will readily understand that the disclosure as discussed above may be practiced with procedures in a different order, and/or with hardware elements in configurations which are different than those which are disclosed. Therefore, although the disclosure has been described based upon these example embodiments, it would be apparent to those of skill in the art that certain modifications, variations, and alternative constructions would be apparent, while remaining within the spirit and scope of example embodiments. Although the above embodiments refer to 5G NR and LTE technology, the above embodiments may also apply to any other present or future 3GPP technology, such as LTE-advanced, and/or fourth generation (4G) technology.

Partial Glossary:
3GPP 3rd Generation Partnership Project
5G 5th Generation
5GCN 5G Core Network
CHO Conditional Handover
DL Downlink
EMBB Enhanced Mobile Broadband
gNB 5G or Next Generation NodeB
GNSS Global Navigation Satellite System
HO Handover
LEO Low Earth Orbit
LTE Long Term Evolution
MIB Master Information Block
NR New Radio
NTN Non-Terrestrial Network
PBCH Physical Broadcast Channel
RACH Random Access Channel
RAN Radio Access Network
RO RACH Opportunity/Occasion
RSRP Reference Signal Received Power
RSRQ Reference Signal Received Quality
SAT Satellite
SIB System Information Block
SSB Synchronization Signal Block
TA Timing Advance
UE User Equipment
UL Uplink
URLLC Ultra Reliable Low Latency Communication

We claim:

1. An apparatus comprising:
at least one processor; and
at least one memory storing instructions that, when executed by the at least one processor, cause the apparatus at least to:
acquire, prior to initiating a handover, assistance information about each target neighboring cell in a list of candidate cells that is on the same satellite or a different satellite as a current cell to which the apparatus is currently connected; and
perform the handover from the current cell to one target neighboring cell from the generated list of candidate cells based on the assistance information.

2. The apparatus of claim 1, wherein the handover is initiated by a handover command from a network entity or in response to satisfying a conditional handover trigger.

3. The apparatus of claim 1, wherein the stored instructions, when executed by the at least one processor, further cause the apparatus at least to:
determine a frequency offset of each candidate cell of the list of candidate cells comprising at least one target neighboring cell relative to the current cell.

4. The apparatus of claim 3, wherein each frequency offset is determined based on measurements of a synchronization information block of the respective target neighboring cell.

5. The apparatus of claim 3, wherein the stored instructions, when executed by the at least one processor, further cause the apparatus at least to:
monitor a plurality of neighboring cells and perform measurements on the plurality of neighboring cells; and
determine the frequency offset of the list of candidate cells based on the measurements performed on the plurality of neighboring cells.

6. The apparatus of claim 1, wherein the assistance information comprises an epoch time.

7. The apparatus of claim 1, wherein the assistance information is acquired about each target neighboring cell in the generated list of candidate cells that is determined to have a non-negative frequency offset.

8. The apparatus of claim 7, wherein the non-negative frequency offset is a positive value or a value indicating that the target neighboring cell is of a same non-terrestrial network satellite as the current cell.

9. The apparatus of claim 1, wherein the stored instructions, when executed by the at least one processor, further cause the apparatus at least to:
classify each target neighboring cell in the list of candidate cells, wherein each target neighboring cell is classified into one classification of a plurality of classifications.

10. A method comprising:
acquiring, prior to initiating a handover, assistance information about each target neighboring cell in a list of candidate cells that is on the same satellite or a different satellite as a current cell to which the apparatus is currently connected; and
performing the handover from the current cell to one target neighboring cell from the generated list of candidate cells based on the assistance information.

11. The method of claim 10, wherein the handover is initiated by a handover command from a network entity or in response to satisfying a conditional handover trigger.

12. The method of claim 10, further comprising:
determining a frequency offset of each candidate cell of the list of candidate cells comprising at least one target neighboring cell relative to the current cell.

13. The method of claim 12, wherein each frequency offset is determined based on measurements of a synchronization information block of the respective target neighboring cell.

14. The method of claim 12, further comprising:
monitoring a plurality of neighboring cells and perform measurements on the plurality of neighboring cells; and
determining the frequency offset of the list of candidate cells based on the measurements performed on the plurality of neighboring cells.

15. The method of claim 10, wherein the assistance information comprises an epoch time.

16. The method of claim 10, wherein the assistance information is acquired about each target neighboring cell in the generated list of candidate cells that is determined to have a non-negative frequency offset.

17. The method of claim 16, wherein the non-negative frequency offset is a positive value or a value indicating that the target neighboring cell is of a same non-terrestrial network satellite as the current cell.

18. The method of claim 10, further comprising:
classifying each target neighboring cell in the list of candidate cells, wherein each target neighboring cell is classified into one classification of a plurality of classifications.

19. A non-transitory computer readable medium comprising program instructions that, when executed by an apparatus, cause the apparatus at least to:
acquire, prior to initiating a handover, assistance information about each target neighboring cell in a list of candidate cells that is on the same satellite or a different satellite as a current cell to which the apparatus is currently connected; and
perform the handover from the current cell to one target neighboring cell from the generated list of candidate cells based on the assistance information.

20. The non-transitory computer readable medium of claim 19, wherein the handover is initiated by a handover command from a network entity or in response to satisfying a conditional handover trigger.
